(19) United States
(12) Patent Application Publication
(10) Pub. No.: US 2023/0228627 A1
(43) Pub. Date: Jul. 20, 2023

(54) BATTERY-OPERATED FOOD THERMOMETER AND MANUFACTURING METHOD

(71) Applicant: Vorwerk & Co. Interholding GmbH, Wuppertal (DE)

(72) Inventors: Matthias Stein, Mülheim an der Ruhr (DE); Mirco Serndt, Velbert (DE); Andres Sauerwald, Bottrop (DE); Gerhard Isenberg, Köln (DE)

(21) Appl. No.: 18/093,172

(22) Filed: Jan. 4, 2023

(30) Foreign Application Priority Data
Jan. 14, 2022 (EP) 22151484.7

(51) Int. Cl. G01K 1/08; H01M 10/658; H01M 50/22

(52) U.S. Cl. CPC G01K 1/08; H01M 10/658; H01M 50/22; G01K 2207/06

(57) ABSTRACT

The present disclosure relates to a food thermometer with a housing comprising a pointed end for a measurement of a temperature inside a product to be cooked. Inside the housing there is a battery arranged at the pointed end of the food thermometer. The battery is encased by a thermal insulation located between the housing and the battery.

The disclosure further relates to a method of manufacturing a food thermometer. Thermally insulating material is brought into a housing part of the housing of the food thermometer and heated. The battery is pushed into the heated thermally insulating material. The thermally insulating material is then cooled.

### PRIORITY CLAIM

This application claims priority to European Patent Application No. 22151474.7, filed Jan. 14, 2022, which is hereby incorporated herein in its entirety.

### FIELD OF THE DISCLOSURE

The present disclosure relates to a food thermometer with a battery. The disclosure also relates to a method of manufacturing a food thermometer.

### BACKGROUND

A food thermometer is a temperature measuring device designed and suitable for measuring temperatures in a food product or foodstuff during its preparation. A food thermometer can therefore measure temperatures that may occur during the preparation of a food. Temperatures that significantly deviate from this cannot be measured. In addition, a food thermometer can withstand the surrounding conditions that can occur during the preparation of a food.

As a rule, temperatures of less than 200° C. are reached when preparing a food. However, temperatures of 350° C. can also be reached, for example for baking a pizza. Temperatures of more than 350° C. are generally not exceeded. A food thermometer in the sense of the present disclosure is therefore configured such that temperatures above 400° C., preferably above 300° C., particularly preferably above 250° C., can no longer be measured. In principle, the food thermometer is configured such that this can be used in a conventional baking oven, i.e. at temperatures of up to 250° C. or 220° C.

### SUMMARY

A food thermometer in the sense of the present disclosure is not designed to be able to measure very low temperatures such as, for example, temperatures significantly below sub-zero temperatures as are reached in household freezers. Thus, a food thermometer in the sense of the present disclosure is not designed to measure temperatures lower than −70° C. In principle, a food thermometer in the sense of the present disclosure is designed so that it cannot measure temperatures below −50° C. because food is generally produced with a supply of heat and very low temperatures are only applied for freezing a food.

A food thermometer in the sense of the present disclosure can withstand a steam atmosphere. A food thermometer is therefore generally encapsulated in a waterproof manner. A food thermometer in the sense of the present disclosure is resistant to common ingredients of a food, such as acid of lemons or vinegar.

A food thermometer according to the present disclosure is intended and suitable to be pierced (inserted) into a product to be cooked to be able to measure a temperature inside the product to be cooked. For this purpose, a food thermometer may comprise an elongated probe having a pointed end or at least a very thin end to enable the probe to be pierced into relatively solid nourishment such as meat. The probe comprises a sensor by means of which a temperature can be measured. A food thermometer may comprise a handle portion that is not intended and suitable to be inserted into the food. The handle portion may be grasped by a user to allow the food thermometer to be withdrawn (removed) from a nourishment or food. The handle portion may also comprise a sensor by means of which a temperature can be measured. The surrounding temperature outside a nourishment or food can then also be measured.

A food thermometer in the sense of the present disclosure requires electrical power for its operation. Thus, an electric food thermometer may comprise a battery, i.e., a storage for electrical energy. The storage can provide the electrical power needed to operate the food thermometer. The battery is basically a rechargeable battery.

The following requirements and problems must be considered for such a food thermometer. A battery is a temperature-sensitive component, which must therefore be well protected from excessive heat, also for safety reasons. In a food thermometer that is pierced into a product to be cooked, the area that remains comparatively cool the longest is the area inside the product to be cooked. This is because in a heated food preparation space, a product to be cooked acts as a thermal insulator. It is therefore advantageous to locate the battery in this area. However, the area to be pierced into the product to be cooked must be as thin as possible so that the food thermometer can be pierced into a product to be cooked without great effort. Therefore, care must be taken to ensure that the battery is of a particularly slim design if it is to be arranged in the area that is to be pierced into a product to be cooked.

The present disclosure pursues the goal of providing a food thermometer that is particularly well suited to the aforementioned requirements.

To solve the problem, a food thermometer comprises the features of claim 1. The additional claim relates to a method for manufacturing the food thermometer. The dependent claims concern advantageous embodiments.

### BRIEF DESCRIPTIONS OF THE DRAWINGS

The present disclosure is explained in more detail below by means of examples illustrated by figures.

The figures show:

FIG. 1: Food thermometer with battery in a double-walled housing;

FIG. 2: Food thermometer with battery and temperature sensor inside a tip;

FIG. 3: Food thermometer with battery and inner wall;

FIG. 4: Food thermometer with battery and phase change material;

FIG. 5: Food thermometer with battery in a housing.

### DETAILED DESCRIPTION

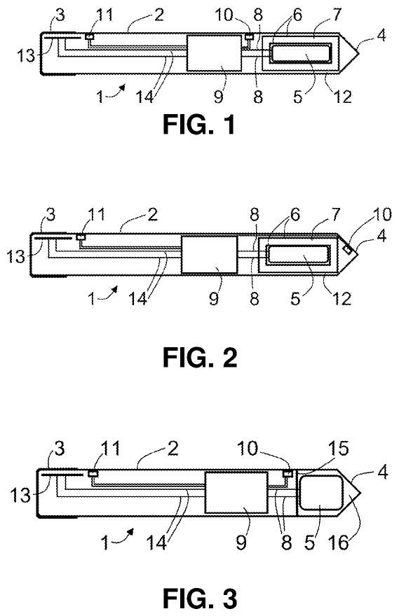

FIG. 1 shows a food thermometer 1. The food thermometer 1 comprises a pin-shaped housing part 2 and a cap 3. The pin-shaped housing part 2 is a tube which is sealed gas-tight at one end by a tip 4. The pin-shaped housing part 2 may consist of metal, such as stainless steel. The cap 3 may be screwed and/or bonded to the pin-shaped housing part 2. The cap 3 may consist of plastic, to be used as a handle protecting from heat. A battery 5 is located at the tip 4. The battery 5 is located within a double-walled housing 6. The interspace 7 between the two walls of the double-walled housing 6 may be filled with gas, such as argon or krypton. Alternatively, a vacuum may prevail in the interspace 7. There may be a phase change material in the interspace 7. The temperature at which the phase changes may be between 40° C. and 53° C.

The double-walled housing 6 may lie against the inner wall of the tip 4 in a punctiform or annular manner and thus be held at one end. Two electrical conductors 8 may connect the battery 5 to electronics 9. The electronics 2 are basically located outside the double-walled housing 6. The two electrical conductors 8 are then passed through the double-walled housing 6. By means of the electronics 9 and the electrical conductors 8, the other end of the double-walled housing 6 can be held. A first temperature sensor 10 electrically connected to the electronics 9 may be attached to the inner wall of the pin-shaped housing part 2 adjacent to the double-walled housing 6. This first temperature sensor 10 can be used to measure the temperature prevailing in a product to be cooked when the food thermometer 1 has been inserted into product to be cooked. A second temperature sensor 11 is located by the cap 3 and is also attached to the inner wall of the housing. The second temperature sensor 11 can be used to measure the temperature prevailing in a cooking space.

The heat storage capacity of temperature sensors 10 and 11 is as small as possible so that the temperature sensors 10 and 11 can react particularly quickly to temperature changes.

There is a circumferential gap 12 between the double-walled housing 6 and the pin-shaped housing part 2. The gap 12 prevents thermal stress. The gap 12 contributes to protecting the battery 5 from being heated.

There may be a coil 13, for example at the cap 3, via which the battery 5 can be inductively charged. The coil 13 may be connected to the electronics 9 via electrical conductors 14. Alternatively, the electrical conductors 14 may be connected to electrical contacts that are accessible from the outside. Charging can then be performed via the contacts.

The electronics 9 may comprise a microcontroller with which the temperature sensors 10 and 11 can be evaluated. The microcontroller can be used to control the charging of the battery 5. The electronics 9 may comprise a radio unit by which the food thermometer can wirelessly exchange data with an external device. An external device, which may be a food processor, for example, can thus receive measured temperatures and control a cooking process depending on the measured temperatures.

The diameter of the conductors 8 can be small compared to other electrical conductors within the food thermometer 1, for example small compared to the electrical conductors 14. Heating of the battery 5 via the electrical conductors 8 is thus avoided.

There is only thermal insulation between the tip 4 and the battery 5, and consequently no further components. The distance between the outermost end of the tip 4 and the battery may be less than 2 cm or 1 cm.

The configuration shown in FIG. 2 differs from the configuration shown in FIG. 1 in that the first temperature sensor 10 is arranged on an inner wall of the tip 4. There is then still the first temperature sensor 10 between the tip 4 and the battery 5, but no further components.

In FIG. 3, a configuration with an inner wall 15 is shown. The inner wall 15 separates a space 16 at the tip 4 from the rest of the inner space of the food thermometer 1 in a gas-tight manner. The battery 5 or a battery 5 with phase change material attached to the surface of the battery 5 is located in the space 16. The attached phase change material may be shape stabilized. The attached phase change material may have been bonded (glued) on. Otherwise, a vacuum may prevail in the space 16. The space 16 may be filled with a thermally insulating gas. However, the space 16 may also be completely filled with a material comprising a phase change material or formed by the phase change material.

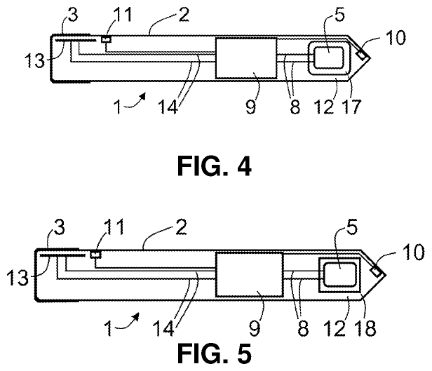

In FIG. 4, a configuration is shown in which a shape stabilized phase change material 17 is attached to the battery 5. This may have been done by filling an area at the tip 4 with phase change material 17 and heating it. Subsequently, the battery has been immersed in the phase change material 17. Cooling has caused the phase change material 17 to contract and thus detach from the pin-shaped housing part 2. To facilitate detachment, a film may be present to separate the phase change material 17 from the pin-shaped housing part 2 at the tip 4.

In FIG. 5, a configuration is shown with a housing 18 in which the battery 5 is located. The battery 5 is spaced from the walls of the housing 18. The housing 18 may be gas-tight, such that a vacuum may be present in the housing 18. Alternatively, a thermally insulating gas or a phase change material may be accommodated in the housing 18. The housing 18 may not not contact the pin-shaped housing part 2 to protect from heat in an improved manner. This is particularly true when a phase change material is present in the housing 18. The housing 18 may be in two parts and may be formed of a container and a lid.

The problem is solved by a food thermometer comprising a housing with a pointed end. The pointed end is intended and suitable for measuring a temperature inside a product to be cooked. A battery is located within the housing. The battery is arranged at the pointed end of the food thermometer. The distance between the extreme end of the tip and the battery is thus small and is, for example, no more than 2 cm, preferably no more than 1 cm. The battery is encased by a thermal insulation located between the housing and the battery. The battery is at least partially covered by the thermal insulation.

A battery is a component that is manufactured separately from other components of the food thermometer. A battery basically comprises a housing. The housing may consist of metal. Inside the housing there may be materials through which electrical energy can be stored electrochemically. There are two electrical conductors. The electrical conductors may be passed through an inner wall inside the housing of the battery. The battery may be a commercially available battery, i.e., commercially available independently of a food thermometer. In particular, the battery is elongated to allow to be suitably accommodated at the tip.

The thermal insulation encases the battery and therefore then extends around the battery. The thermal insulation may then be shaped like a tube. Preferably, the battery is completely inside the thermal insulation so that the end faces of the battery are also covered by the thermal insulation.

However, it is also possible that the thermal insulation only partially covers the battery. For example, the thermal insulation may be lattice-like and therefore only partially cover the battery. The thermal insulation could consist of several elements that have been bonded (glued) to the battery, for example. If there is a distance between the elements, the thermal insulation only partially covers the battery. The elements can be different. There may be one or more first elements that comprise a thermally insulating gas or a thermally insulating vacuum, thereby providing thermal insulation. One or more second elements may be present that comprise a phase change material and thereby thermally insulate. If a battery is only partially covered, the battery is nevertheless generally predominantly covered. Generally, at least 80% of the surface area of the battery is covered by the thermal insulation, preferably at least 90%. A thermal insulation that completely covers the surface of the battery, i.e. 100%, is preferred.

A thermal insulation in the sense of the present disclosure is a material that is better able to protect against heat than the material adjacent to the thermal insulation. For example, the thermal conductivity of the thermal insulation may be lower than the thermal conductivity of the materials adjacent thereto. One or more materials adjacent thereto may consist of metal. One or more materials adjacent thereto may consist of stainless steel. For example, the housing of the food thermometer and/or the housing of the battery may consist of metal such as stainless steel. The thermally insulating material may then have the housing of the food thermometer, which consists of metal, adjacent to one side thereof and/or the housing of the battery, which consists of metal, adjacent to the other side thereof.

A too high temperature can destroy a battery. Thermal insulation is not required to protect against such high temperatures. Therefore, thermal insulations are not provided for food thermometers at least when the battery is placed at a tip of a food thermometer. First, arranging a battery at the tip of a food thermometer protects against heat because the product to be cooked acts as a thermal insulator when the tip is inserted into the product to be cooked. Second, the thermometer must be thin at the tip to be able to be pierced into the product to be cooked without leaving excessively large holes in the product to be cooked. Therefore, additional thermal insulation is unfavorable because it increases the diameter of the food thermometer in the area of the tip.

A battery is subject to aging phenomena. Care must be taken in a food thermometer to ensure that a battery in a food thermometer is able to provide sufficient electrical energy for several years to operate the food thermometer. Thus, even after several years, there must still be a sufficient minimum capacity so that the food thermometer can measure temperatures for a sufficiently long time during the preparation of food. Otherwise, the food thermometer could no longer be used after only a short time.

The present disclosure is based on the realization that aging phenomena of a battery can be greatly reduced if the battery of a food thermometer is not only located at the tip of the food thermometer, but is additionally protected by a thermally insulating layer. This makes it possible to use a battery with a relatively low capacity, which, in return, is comparatively slim and small. Thus, despite the thermal insulation, it is possible to make the area at the tip of a food thermometer thin. This also allows the use of smaller batteries, even if they age in a particularly temperature-sensitive manner.

As a battery, a Li-ion battery or a battery with a solid as electrolyte can be used. A battery with a ceramic electrolyte can also be selected. Alternatively, for example, a supercapacitor can be provided as a battery.

The thermal insulation may be provided by a vacuum or by a well thermally insulating gas such as argon or krypton. In principle, there is then no other component of the food thermometer between the outermost end of the tip and the battery. There may be a temperature sensor adjacent to an inner wall of the tip, which may be supplied with electrical power via the battery. In this case, only the temperature sensor can be located between the outermost end of the tip and the battery.

Inside the thermometer, in the case of vacuum or a thermally insulating gas, there is an inner wall which separates the space at the tip from the rest of the inner space of the food thermometer in an airtight manner. The battery is then located in the inner space at the tip. Thermal insulation realized by a gas or a vacuum is advantageously insensitive to heat. Moreover, no destructive thermal stress due to temperature changes occurs.

The inner wall may consist of metal and be bonded to the housing, for example. The inner wall may consist of a plastic or resin. Plastic and/or resin are then basically selected in such a way that they can withstand temperatures of at least 200° C. or 220° C. and do not liquefy at 200° C. or 220° C., for example.

The thermal insulation may be formed by a phase change material. The phase change material may be accommodated together with the battery in a closed space which is located at the tip and/or present in the tip. The phase change material may then be a liquid that is vaporized by heat supply, thus changing its phase. The phase change material may be in the form of a paste. The thermal insulation may consist of a combination of a phase change material and a vacuum, or a combination of phase change material and a thermally insulating gas. The thermal insulation can thus be further improved. The installation space required for this can be kept small.

The heat storage capacity of the phase change material is preferably as large as possible in order to be able to achieve a sufficiently large cooling effect for a long time.

The phase change temperature at which the phase change takes place is below the maximum possible operating temperature of the food thermometer, as otherwise no phase change can take place. The phase change temperature is basically selected so that it is below the maximum temperature to which the battery should be exposed during discharging. The phase change temperature is preferably selected so that it is lower than the maximum charging temperature of the battery in order to be able to charge the battery particularly quickly. Longer charging times can thus be advantageously avoided. The phase change temperature should therefore be no more than 70° C., preferably no more than 60° C. The phase change temperature is also selected so that it is above usual storage temperatures. The phase change temperature is therefore generally above usual room temperatures. The phase change temperature should be at least 30° C., preferably at least 40° C. The phase change temperature at which the phase changes should be between 40° C. and 53° C. for the aforementioned reasons.

In some embodiments, the phase change material has a distance to the housing of the food thermometer. For example, a gap filled with air then remains between the phase change material and the housing. The gap is present at least when the temperature of the phase change material is below the temperature at which the phase change occurs. This further protects the battery in an improved manner from excessive heat. Also, detrimental thermal stress is avoided.

The gap may be filled with a thermally insulating gas. A vacuum may be present in the gap to thermally insulate in a further improved manner. The thermal insulation may be formed particularly effectively by such a combination of phase change material and vacuum or by a combination of phase change material and thermally insulating gas such as argon or krypton. The installation space required for this can nevertheless be slim.

Preferably, the phase change material is dimensionally stabilized. This can ensure that there is a gap between the housing of the food thermometer and the phase change material at least when the temperature of the phase change material is below the temperature at which the phase change takes place.

The thermal insulation may be formed by a composite material that comprises the phase change material. The phase change material can be dimensionally stabilized in this manner. The phase change material may be encapsulated and thereby dimensionally stabilized. The phase change material may be macroencapsulated or microencapsulated. The phase change material may be encased by a film, for example. The film may be stretchable to accommodate volume changes of the phase change material. The film may consist of plastic.

The thermally insulating material may have been bonded to the battery. The battery may have been pushed into an enclosure made of thermally insulating material. The enclosure can have been closed with a lid. The battery and thermal insulation may then have been brought into the food thermometer housing.

The capacity of the battery should be at least 100 μAh, preferably at least 500 μAh, in order to be able to achieve sufficiently long operating times of the food thermometer for the preparation of foods. The capacity of the battery should be no more than 3 mAh, preferably no more than 2 mAh, in order to be able to keep diameters at the tip of the food thermometer low.

The housing of the food thermometer may consist entirely or at least predominantly of metal, preferably stainless steel. The housing can thus have a good thermally conductivity so as to be able to measure temperatures quickly. The housing can thus cope well with thermal, chemical and mechanical requirements.

A box may be provided in which the food thermometer can be stored in a thermally protected manner. A substantially constant storage temperature can thus be ensured. The box can be designed in such a way that it can serve as a charger for the battery of the food thermometer.

To manufacture a food thermometer with a thermally insulated battery, thermally insulating material can be brought into a housing part comprising a pointed end. The thermally insulating material can be heated, for example, to a temperature of at least 40° C., 60° C. or 80° C. The battery can then be inserted into the heated thermally insulating material. When the thermally insulating material is subsequently cooled, this may cause a gap to form between the thermally insulating material and the housing. The battery may be held in a desired position within the housing by electrical conductors connected to the battery. The electrical conductors may pass through an inner wall to fix the position of the electrical conductors within the food thermometer. The inner wall may thus contribute to holding the battery.

The thermally insulating material may comprise a phase change material. The thermally insulating material to be heated for manufacturing may be a granule comprising a phase change material.

The use of a phase change material can be particularly preferable because this is able to protect the battery particularly well also from excessively low temperatures of, for example, less than 0° C. If temperatures of, for example, less than 10° C. or less than 0° C. are to be measured with the food thermometer, the food thermometer is preferably brought to a temperature above the phase change temperature before measurement until the phase change material has changed its phase at least predominantly, preferably completely. If a low temperature is measured subsequently, the phase change material protects the battery particularly well against cold.

1. A food thermometer comprising
a housing having a pointed end for a measurement of a temperature inside a product to be cooked,
a battery located inside the housing and arranged at the pointed end of the food thermometer,
wherein the battery is encased by a thermal insulation located between the housing and the battery, or that the battery is at least partially covered by a thermal insulation located between the housing and the battery.

2. The food thermometer of claim 1, wherein the battery is located in a space (16) inside the food thermometer in which a vacuum prevails or which is filled with a thermally insulating gas.

3. The food thermometer of claim 2, wherein the thermally insulating gas is argon or krypton.

4. The food thermometer of claim 1, wherein the thermal insulation comprises a phase change material.

5. The food thermometer of claim 4, wherein the phase change material is spaced from the housing of the food thermometer.

6. The food thermometer of claim 5, wherein the phase change material is dimensionally stabilized.

7. The food thermometer of claim 4, wherein the phase change material is dimensionally stabilized.

8. The food thermometer of claim 7, wherein thermal insulation comprises a composite material comprising the phase change material or that the phase change material is encapsulated.

9. The food thermometer of claim 1, wherein thermally insulating material is bonded to the battery.

10. The food thermometer of claim 1, wherein the battery is in an enclosure of thermal insulating material

11. The food thermometer of claim 1, wherein the thermal insulation is formed of a plurality of elements or that the thermal insulation is lattice-shaped.

12. The food thermometer of claim 1, wherein battery is selected to have a capacity of at least 100 μAh and/or of not more than 3 mAh.

13. The food thermometer of claim 1, wherein the housing consists entirely or at least predominantly of metal.

14. The food thermometer of claim 13, wherein the housing consists predominantly of stainless steel.

15. A method for manufacturing a food thermometer, the method comprising
bringing thermally insulating material into a housing part of the housing of the food thermometer,
heating the thermally insulating material,
pushing the battery into the heated thermally insulating material, and
cooling the thermally insulating material,
wherein the manufactured food thermometer comprises
a housing having a pointed end for a measurement of a temperature inside a product to be cooked,
a battery located inside the housing and arranged at the pointed end of the food thermometer,
the battery being encased by a thermal insulation located between the housing and the battery, or the battery being at least partially covered by a thermal insulation located between the housing and the battery.

16. The method of claim 15, wherein the battery is held in such a way that the cooling causes a gap between the thermally insulating material and the housing.

17. The method of claim 16, wherein the battery is held by electrical conductors.

18. The method of claim 17, wherein the electrical conductors are passed through an inner wall.

19. The method of claim 18, wherein the inner wall contributes to holding the battery.
